(19) United States
(12) Patent Application Publication
(10) Pub. No.: US 2002/0064762 A1
(43) Pub. Date: May 30, 2002

(54) Coloring book

(76) Inventors: Leslie Kenworthy Avery, Toluca Lake, CA (US); Michael Kenworthy, Toluca Lake, CA (US)

Correspondence Address: Michael L. Greenberg, 314 Philadelphia Ave, Takoma Park, MD, 20912, US

(21) Appl. No.: 09/824,894

(22) Filed: Apr. 3, 2001

Related U.S. Application Data
(60) Provisional application No. 60/194,039, filed on Apr. 3, 2000.

(51) Int. Cl. G09B 11/00

(52) U.S. Cl. 434/81

(57) ABSTRACT

A coloring book with removable vinyl sheets that can be placed over picture templates is described. The user can then color on the vinyl and transport the art to a display position, for example, on a window, or refrigerator door. The vinyl has inherent static cling properties that adhere the drawing to the flat surface. The product also has conventional dry erase markers to use on the vinyl for coloring purposes.

This Application claims the benefit of priority from U.S. Provisional Application No. 60/194,039 filed on Apr. 3, 2000, in the names of Leslie Kenworthy Avery and Michael Kenworthy entitled Coloring Book.

### FIELD OF THE INVENTION

The present invention is related to coloring books, specifically, a coloring book in which a clear vinyl sheet covers the preprinted pages conventionally colored upon.

### BACKGROUND OF THE INVENTION

Travelers often get restless when a family vacation or a school field trip requires a substantial amount of transportation time. It is difficult and tiresome for adults to entertain children during these times because they may be busy driving or following directions to the destination. Several inventions have been created which attempt to entertain children during this time, but it is difficult to play games which require multiple small pieces because they are easily lost during transport. Also these games often require more than one child to play. This creates an obvious problem if only one child is present.

A simple and fun activity in which children enjoy partaking is coloring and drawing. This activity appeals to children of all ages and both genders because of the diversity of creative expression it harbors. This also familiarizes children with the concept of writing and the proper way in which to hold markers or pens, and is a way to easily coach children in learning their colors, furthering their academic development.

The finished colored product often gives the artist a sense of accomplishment and pride. Parents and teachers often reward a child's artistic vision by displaying their work on the refrigerator at home or bulletin board at school. By the same token, the masterpieces created during while traveling should be displayed for others to admire.

U.S. Pat. No. 5,269,691 issued to Waldman on Dec. 14, 1993 relates to a sticker book which has several sheets of stickers and twelve pages of a book whose pages have a release coating for the aforementioned stickers. The stickers given are to be arranged in various patterns and scenes printed within the book. Unlike the present invention, Waldman's invention involves the temporary placement of given stickers onto specific pages from which they can be removed. Children are not able to draw or color using this invention, and their work will not be in a form that can be displayed on a window.

U.S. Pat. No. 4,875,707 issued to Krom on Oct. 24, 1989 describes a carrying device which holds a coloring book and crayons. This book-like receptacle allows crayons to be inserted into cylinders on opposing book surfaces so that the alternative alignment of crayons allows the book, in a closed position, to form an inter-digital type registry. There is also a fastener on the outside of the back cover so that a coloring book may be attached. Unlike the present invention, Krom's device is merely a holding device for a set of crayons and a coloring book. It is not a coloring book in and of itself. This device allows these objects to be transported in an organized fashion, but does not provide a method to display the art work.

U.S. Pat. No. 5,836,615 issued to Elliot, et al. for a book with releaseable adhesive is for an invention in which an adhesive is applied to the binding of a conventional book construction. The pages are reasonably secured against the inherently tacky binding so that the pages may be removed and subsequently resecured numerous times. Unlike the present invention, Elliot et al's invention is not related to coloring books and the adhesive used to remove and resecure the pages to the book is in inherently tacky substance rather than a vinyl sheet which is removed and affixed due to the characteristics of static cling.

U.S. Pat. No. 5,842,720 issued to Ward on Dec. 1, 1998 is related to reinforcement strips for looseleaf pages containing a pressure sensitive adhesive. Unlike the present invention, these clear strips are not intended to be drawn upon, are not removable once applied to the paper surface, and do not use a static cling mechanism to adhere to surfaces.

U.S. Pat. No. 5,914,158 issued to McGuiness on Jun. 22, 1999 for a static cling greeting card describes a card with a removable, thin, vinyl sheet which can be removed and placed on a flat smooth surface without the use of adhesives. The sheet may be from a greeting card or postcard and may contain letters, photographs, or a multitude of other types of visual data. Unlike the present invention, however, this invention is not a coloring book and is not meant to be drawn upon. Also, the visual data is of a more permanent nature on McGuiness's invention, unlike the present invention in which dry erase markers are used to create a more temporary result.

U.S. Pat. No. 5,899,010 issued to Peck on May 4, 1999 is for a static cling banner. A plastic material is used as a reusable banner to which a variety of letters, shapes, and numbers can be electrostatically applied to make a sign, but easily removed and rearranged to facilitate temporary use. Unlike the present invention, the indica are meant to be applied only to given plastic banner and the opportunity for children to draw on a clear vinyl sheet is not offered.

U.S. Design Pat. No. 412,184 issued to Garrett on Jul. 20, 1999 is for an automobile window decal. Unlike the present invention, this decal is for a specific ornamental design and is affixed to the window using a permanent adhesive rather than by a static cling mechanism for temporary attachment.

### SUMMARY OF THE INVENTION

The present invention is a coloring book with a multitude of pre-printed drawings. Unlike a conventional coloring book, there is a clear vinyl sheet overlaying the pre-printed sheets of the book. The vinyl sheets are not bound within the book as the pictures are, but rather, remain affixed upon the image in the book through the force of static cling. A person can draw on the clear vinyl sheet with conventional dry erase markers. When the person is done coloring on the vinyl sheet, the sheet can be easily removed and displayed on any smooth surface such as a window, mirror, or refrigerator door. Similar to the way the sheet was attached to the pages of the book, static cling forces keep the sheet attached to the window.

### DETAILED DESCRIPTION OF THE INVENTION

The present invention is a coloring book inside of which are the pre-printed pages, which serve as drawing templates, as well as several clear, vinyl sheets. The vinyl sheets are not bound within the book as the pre-printed templates are. Instead, they remain inside the present invention through conventional static cling forces.

When using the present invention, a single vinyl sheet is removed from the back of the present invention and placed directly on top of a pre-printed template. Conventional non-toxic, dry-erase markers are used to trace the figure from the present invention onto the vinyl sheet as well as to color in the picture from the template. These markers have a handy pencil case type pouch attached to the front of the present invention, so that the chance of separation from the present invention is lessened. The dry-erase markers provide a temporary image, so the artist has the ability to correct mistakes and make sure s/he stays within the lines of the drawing.

When the drawing and coloring is completed, the vinyl sheet can be removed from the present invention and affixed to a smooth, flat surface such as a window, wall, or door. The vinyl sheet would remain in place on a vertical surface through the same conventional forces of static cling. Artwork is therefore displayed without the use of adhesives that could potentially leave a tacky residue on window or door surfaces. This can create a display place for artwork even while traveling on car, plane, train, or bus windows.

The drawings can be easily erased by applying a damp paper towel to the picture due to the inherent nature of dry-erase markers. The vinyl sheets can therefore be used repeatedly. However, several sheets are included with the coloring book so that a person has the option of continuing to create their artwork while previous works remain in tact. In this manner a child can work on more than one drawing at a time by flipping from one to another. The inherent static cling of the vinyl sheets can hold the drawings in place during the change from one to another.

The present invention is ideal for people to use at home or during travel. There are a minimal number of materials required to participate in the activity. Dry-erase markers do not require sharpening as crayons do, and cannot potentially melt into a waxy mess if left inside a hot car. Also, the artists final artwork can be displayed in the windows of cars, planes, trains, and buses for others to admire.

The templates (200 are included in the book) will help young children learn to identify common objects in their everyday world, such as cars, and still feed their imagination with creatures such as dinosaurs, or animated flowers. The tabs at the bottom of each section are clearly printed in capital block print, giving children a chance to associate words with forms enhancing the beginning reading process. The section of vinyl is located at the back of the drawings and is delineated by it's own tab.

The book has a spiral binding that securely holds each page in place and secures the pouch that contains the markers. The front and back covers are constructed of a heavy card stock that would not be easily ripped or disconnected. This will extend the life of the present invention and protect the template drawings. Starting from the front there are six different sections of picture templates. The categories of pictures are Flowers, Cars, Bugs, Dinosaurs, Animals, and Scenes.

The paper that the picture templates are printed on is of a heavy weight and is glossy with clear bold black print. After the sections of templates is the section of vinyl. The forces of static cling adhere each sheet of vinyl to paper so that they are both easily removed and not apt to fall from the present invention.

Primarily the present invention is intended to be a coloring book containing self adhesive vinyl to use above picture templates for coloring purposes with dry erase markers, but is not exclusively limited hereto. It is understood that the present invention is not limited to the sole embodiment described above, but encompasses any and all embodiments within the scope of the following claims.

I claim:

1. A coloring book apparatus, comprising:
at least one coloring template;
at least one sheet of vinyl, adapted to be placed atop said at least one coloring template; and
at least one dry erase marker, disposed in proximity to said at least one coloring template.

2. A coloring book apparatus as in claim 1, wherein said at least one coloring template and said at least one sheet of vinyl are in a hard-sided book.

3. A coloring book apparatus as in claim 2, wherein said at least one dry erase marker is contained in a resealable pouch.

4. A coloring book apparatus as in claim 3, wherein said resealable pouch is attached to said hard-sided book.

5. A coloring book apparatus as in claim 1, wherein said at least one sheet of vinyl is attached via static cling force to said at least one coloring template.

6. A coloring book apparatus as in claim 2, wherein said at least one sheet of vinyl is held in said hard-sided book by forces of static cling.

7. A coloring book apparatus, comprising:
a series of coloring templates;
at least one sheet of vinyl, adapted to be placed atop said at least one coloring template; and
a series of tabs corresponding to said series of coloring templates.

8. A coloring book apparatus, comprising:
at least one coloring template;
at least one sheet of vinyl, disposed atop said at least one coloring template;
at least one dry erase marker, disposed in proximity to said at least one coloring template;
a spiral binding, holding said coloring template;
a pouch for containing said at least one dry erase marker, said pouch attached to said spiral binding; and
a cover attached to said spiral binding.
